(19) United States
(12) Patent Application Publication
(10) Pub. No.: US 2014/0181725 A1
(43) Pub. Date: Jun. 26, 2014

(54) APPARATUS AND METHOD FOR EXECUTING APPLICATION

(71) Applicant: Pantech Co., Ltd., Seoul (KR)

(72) Inventors: Dong Ho YANG, Seoul (KR); Jong Kwon LEE, Seoul (KR); Hyun Young CHO, Seoul (KR)

(73) Assignee: Pantech Co., Ltd., Seoul (KR)

(21) Appl. No.: 14/132,793

(22) Filed: Dec. 18, 2013

(30) Foreign Application Priority Data
Dec. 20, 2012 (KR) 10-2012-0149681

(51) Int. Cl. G06F 3/0481

(52) U.S. Cl. CPC G06F 3/0481
USPC 715/777; 715/781

(57) ABSTRACT

An apparatus to provide an interface for multiple widgets includes a storage device to store a widget, a controller to control the widget in a widget window configured to be displayed on a layer different from a layer for displaying an executable application, and a display to display the widget window. A method for providing an interface for multiple widgets includes receiving an input to display a widget window, and displaying a widget window on a layer different from a layer for displaying an executable application. The widget window is configured to manage multiple widgets.

### CROSS-REFERENCE TO RELATED APPLICATIONS

This application claims priority from and the benefit under 35 U.S.C. §119(a) of Korean Patent Application No. 10-2012-0149681, filed on Dec. 20, 2012, which is hereby incorporated by reference for all purposes as if fully set forth herein.

### BACKGROUND

1. Field

Exemplary embodiments of the present invention relate to an apparatus and a method for executing an application of a mobile communication terminal.

2. Discussion of the Background

With the introduction and growing prevalence of smartphone technology, mobile communication terminals support a variety of functions, not only just audio communications but also Internet, texting, and multimedia functions similar to functions performed in a portable computer. Further, as demands of users become diverse and specific, users have needs to utilize the screen of a mobile communication terminal in various and effective ways.

Regarding mobile communication terminals, a method of quickly connecting to an application has been suggested to realize easy and convenient access to a favorite application. For example, a method of disposing at least one application in a widget form on a screen on which another application is running has been introduced.

A widget may be disposed in different sizes on a home screen and be immediately implemented on the home screen upon being selected by a user.

A general method of registering a widget in the home screen includes selecting a widget to be registered from a widget list, determining whether the widget may be disposed on the home screen, and disposing the selected widget at a position if there is a sufficient space for the widget.

Typically, a mobile communication terminal may change to a home screen and register and run a widget through a widget setup screen, thereby registering and running the widget on the home screen.

However, if there is no space for a new widget on the home screen, the mobile communication terminal does not register the widget and thus the user may need to delete an existing widget or other icons or applications, to switch a current screen to another screen such that the new widget does not overlap an existing widget, or to generate a new screen for the registration of the new widget. To implement the registered widget, a user may be inconvenienced by being required to switch to the screen on which the widget is registered and to retrieve the widget if a user disposes a plurality of widgets on separate screens during registration due to the limited space for the widgets.

### SUMMARY

Exemplary embodiments of the present invention provide an apparatus and a method for executing an application of a mobile communication terminal.

Additional features of the invention will be set forth in the description which follows, and in part will be apparent from the description, or may be learned by practice of the invention.

Exemplary embodiments of the present invention provide an apparatus to provide an interface for multiple widgets, the apparatus including: a storage device to store a widget; a controller to control the widget in a widget window configured to be displayed on a layer different from a layer for displaying an executable application; and a display to display the widget window, the widget window being configured to manage multiple widgets.

Exemplary embodiments of the present invention provide a method for providing an interface for multiple widgets, the method including: receiving an input to display a widget window; and displaying a widget window on a layer different from a layer for displaying an executable application, the widget window being configured to manage multiple widgets.

Exemplary embodiments of the present invention provide a non-transitory computer-readable recording medium including an executable program for instructing a computer, when executed by the computer, to perform: receiving an input to display a widget window; and displaying a widget window on a layer different from a layer for displaying an executable application, the widget window being configured to manage multiple widgets.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a configuration of an application executing apparatus according to an exemplary embodiment of the present invention.

FIG. 2 is a block diagram illustrating a widget service providing structure according to an exemplary embodiment of the present invention.

FIG. 3 is a block diagram illustrating additional components of an application executing apparatus to collect widget property information and to configure widget list information according to an exemplary embodiment of the present invention.

FIG. 4 illustrates a widget executed and displayed on a multi-execution window according to an exemplary embodiment of the present invention.

FIG. 5 illustrates a display location of the multi-execution window according to an exemplary embodiment of the present invention.

FIG. 6 illustrates a widget executed and displayed on the multi-execution window according to another exemplary embodiment of the present invention.

FIG. 7 is a block diagram illustrating a configuration of a processing unit according to an exemplary embodiment of the present invention.

FIG. 8 illustrates a displayed multi-execution window according to an exemplary embodiment of the present invention.

FIG. 9 illustrates a displayed multi-execution window according to another exemplary embodiment of the present invention.

FIG. 10 illustrates a widget list or an application list to be registered in a widget tab or folder tab through a setup tab according to an exemplary embodiment of the present invention.

FIG. 11 illustrates that an application icon selected from an application list is registered in a folder tab of a multi-execution window according to an exemplary embodiment of the present invention.

FIG. 12 is a flowchart illustrating an application executing method according to an exemplary embodiment of the present invention.

FIG. 13 is a flowchart illustrating a method of changing a layout of a widget based on a change of widget property information according to an exemplary embodiment.

FIG. 14 is a flowchart illustrating a method of registering a widget in a multi-execution window according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. Throughout the drawings and the detailed description, unless otherwise described, the same reference numerals will be understood to refer to the same respective elements, features, and structures. The relative size and depiction of these elements may be exaggerated for clarity, illustration, and convenience.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the specification, a “widget” may be a graphic interface to support smooth interactions between users and applications/operating systems. A widget may enable a user to instantly use a desired service on an idle screen of a terminal without implementing a particular application when the user uses a function of the particular application, and enable a user to immediately utilize a desired service on the idle screen of the terminal without visiting a portal service or a content providing site.

A background service may refer to a background process of performing a particular task periodically or in a certain period without a user interface (UI), and the term “widget service” is a service operated in connection with a widget.

A mobile communication terminal includes a mobile communication terminal control unit, and may include any information and communication device, multimedia equipment and applications. For example, a mobile communication terminal may be one of a portable terminal, a digital broadcast terminal, a personal digital assistant (PDA), a smartphone, an International Mobile Telecommunication 2000 (IMT-2000) terminal, a Wideband Code Division Multiple Access (WCDMA) terminal and a Universal Mobile Telecommunication Service (UMTS) terminal, but is not limited thereto.

For instance, a mobile communication terminal may include a wireless communication unit, an audio/video (A/V) input unit, a user input unit, a sensing unit, an output unit, a memory, an interface unit, a controller, and a power supply unit. However, the mobile communication terminal may not necessarily include all these components but may be configured to include more or fewer components.

A wireless communication unit may include at least one component that enables wireless communications between a mobile communication terminal and a wireless communication system and/or between networks with which a mobile communication terminal communicates. For example, the wireless communication unit may include a broadcast reception unit, a mobile communication unit, a wireless Internet unit, a local area network (LAN) communication unit, and a location information transmission and reception unit.

The broadcast reception unit may receive a broadcast signal and/or broadcast related information from an external broadcast management server through a broadcast channel. The broadcast channel may include a satellite channel and a terrestrial channel. The broadcast management server may refer to a server that generates and transmits a broadcast signal and broadcast related information or a server that is provided with a broadcast signal or broadcast related information generated in advance and transmits the broadcast signal or broadcast related information to a terminal. The broadcast related information may refer to information about a broadcast channel, a broadcast program or a broadcast service provider. The broadcast signal may include not only a TV broadcast signal, a radio broadcast signal and a data broadcast signal, but a combination of a TV broadcast signal or a radio broadcast signal with a data broadcast signal. The broadcast related information may be provided through a mobile communication network, and may be received by a mobile communication unit.

The broadcast related information may be in various forms, for example, an electronic program guide (EPG) of Digital Multimedia Broadcasting (DMB) or an electronic service guide (ESG) of Digital Video Broadcast-Handheld (DVB-H).

The broadcast reception unit may receive a broadcast signal using various kinds of broadcast systems, particularly a digital broadcast signal using a digital broadcast system, such as Digital Multimedia Broadcasting-Terrestrial (DMB-T), Digital Multimedia Broadcasting-Satellite (DMB-S), Media Forward Link Only (MediaFLO), DVB-H and Integrated Services Digital Broadcast-Terrestrial (ISDB-T). The broadcast reception unit may be configured for any broadcast system that provides a broadcast signal as well as the digital broadcast systems described above.

The broadcast signal and the broadcast related information received through the broadcast reception unit may be stored in a memory.

The mobile communication unit may transmit/receive a wireless signal to/from at least one of a base station, an external terminal and a server in the mobile communication network. Here, the wireless signal may include diverse forms of data signals for transmission and reception of a voice call, a video call or a text/multimedia message, and the like.

The wireless Internet unit includes a module for wireless connection to the Internet, which may be embedded in the mobile communication terminal, installed outside the mobile communication terminal, or configured to be connected to the mobile communication terminal. As the wireless Internet technology, Wireless LAN (WLAN), Wi-Fi, Wireless broadband (Wibro), World Interoperability for Microwave Access (Wimax) and High Speed Downlink Packet Access (HSDPA) may be used.

The Local Area Network (LAN) communication unit includes a module for LAN communications. As LAN communication technology, Bluetooth, Radio Frequency Identification (RFID), Infrared Data Association (IrDA), Ultra Wideband (UWB), ZigBee, and the like may be used.

The location information transmission and reception unit refers to a module to identify or acquire a location of the mobile communication terminal. The location information transmission and reception unit may be, for example, a global positioning system (GPS) module. The GPS module may calculate distances from three or more satellites and accurate time and apply triangulation to the calculated information, thereby calculating accurate three-dimensional location information based on latitude, longitude and altitude. In general, a method in which three satellites are used to calculate location and time information and another satellite is used to correct an error in the calculated location and time information is widely used. Further, the GPS module may continuously calculate the current location in real time to calculate speed information.

The A/V input unit is for inputting an audio signal and/or a video signal and may include a camera and a microphone. The camera processes an image frame obtained by an image sensor in an image capturing mode, for example, a video call mode or shooting mode, such as a still image or a video. The processed image frame may be displayed on a display unit.

The image frame processed by the camera may be stored in the memory or transmitted to the outside, e.g., a receiver, another terminal, and the like, through the wireless communication unit. Two or more cameras may be provided depending on a configuration of the terminal. The microphone receives an input of an external sound signal in a call mode, record mode or voice recognition mode and processes the signal into voice data. In such modes, the processed voice data may be converted into a transmittable form and may be transmitted to the mobile communication base station through the mobile communication unit. Various noise reduction algorithms may be used to remove noise generated when the microphone receives the external sound signal.

The user input unit generates input data for a user to control an operation of the terminal. The user input unit may include a keypad, a dome switch, a pressure-constant or electrostatic touchpad, a jog wheel, a jog switch, a touchscreen, and the like. In particular, a layer structure formed of the touchpad and the display unit may be referred to as a touchscreen.

The sensing unit detects a current state of the mobile communication terminal, for example, whether the mobile communication terminal is open or closed, a location of the mobile communication terminal, whether the mobile communication terminal is touched by a user, a direction of the mobile communication terminal, and whether the mobile communication terminal accelerates or decelerates, and generates a sensing signal to control an operation of the mobile communication terminal. For example, if the mobile communication terminal is a slide phone, the sensing unit may sense whether the slide phone is open or closed. Further, the sensing unit may sense whether the power supply unit supplies power and/or whether the interface unit is connected to an external device. The sensing unit may include a proximity sensor, which will be described in connection with the touchscreen.

Further, the sensing unit may include a geomagnetic sensor to calculate a direction of a moving user, a gyro sensor to calculate a rotation direction, and an accelerometer to calculate a moving distance by multiplying a number of steps by a length of one step.

The interface unit serves to provide an interface with one or more external devices connected to the mobile communication terminal. For example, the interface unit may include a wire-based/wireless headset port, an external charger port, a wire-based/wireless data port, a memory card port, a port to connect a device having an identification module, an audio input/output (I/O) port, a video I/O port, and an earphone port.

Here, the identification module is a chip to store various kinds of information for authentication of authorization to use the mobile communication terminal and may include a User Identity Module (UIM), a Subscriber Identity Module (SIM), and a Universal Subscriber Identification Module (USIM). Further the device having the identification module (hereinafter, “identification device”) may be manufactured in a smart card form. Thus, the identification device may be connected to the terminal through a port. The interface unit may receive data from an external device or be provided with power to transmit the data or power to each component of the mobile communication terminal or transmit data in the mobile communication terminal to the external device.

Also, the interface unit may serve as a path through which power from an external cradle is supplied to the mobile communication terminal when the mobile communication terminal is connected to the cradle, or as a path through which diverse command signals input by a user from the cradle are transmitted to the mobile communication terminal. The diverse command signals or power input from the cradle may operate as a signal to recognize that the mobile communication terminal is properly mounted on the cradle.

The output unit may output an audio signal, a video signal or an alarm signal and may include a display unit, a sound output unit, and an alarm unit.

The display unit displays information processed in the mobile communication terminal. For example, when the mobile communication terminal is in the call mode, the display unit displays a user interface (UI) or graphic user interface (GUI) related to a call. When the mobile communication terminal is in the video call mode or shooting mode or an image capturing mode, the display unit displays a taken image and/or received image, a UI or a GUI.

As described above, in the touchscreen that may be a layer structure formed of the display unit and the touchpad, the touchscreen including the display unit may be used as an input device as well as an output device. The display unit may include a liquid crystal display (LCD), a thin film transistor (TFT)-LCD, an organic light emitting diode (OLED), a flexible display and a three-dimensional (3D) display, and the like. Some of these displays may be formed as a see-through structure to enable a user to see the inside, rear side or the background of display, which may be called a transparent display. A representative transparent display is a transparent organic light emitting diode (TOLED). Two or more displays may be present based on a configuration of the mobile communication terminal. For instance, the mobile communication terminal may include an external display and an internal display. The touchscreen may be configured to detect both the position and area of a touch input and the pressure of the touch input.

The sound output unit outputs audio data received from the wireless communication unit in response to a call signal in a call mode, a record mode, a voice recognition mode or a broadcast reception mode or outputs audio data stored in the memory. Further, the sound output unit outputs a sound signal related to a function of the mobile communication terminal, for example, a call signal arrival sound and a message arrival sound. The sound output unit may include a speaker and/or a buzzer.

The alarm unit outputs a signal to report occurrence of an event of the mobile communication terminal. The event occurring in the mobile communication terminal may include, for instance, call signal reception, message reception, key signal input, and touch input. The alarm unit may output the signal to report the occurrence of the event in different ways through an audio signal, a video signal, or a vibration. If a call signal or message is received, the alarm unit may output vibrations to report the reception of the call signal or message. Further, if a key signal is input, the alarm unit may output vibrations as a feedback in response to the input of the key signal. The output vibrations enable a user to recognize the occurrence of the event. The signal to report the occurrence of the event may be output through the display unit or the sound output unit.

The memory may store a program for processing and controlling of the controller and temporarily store input/output data, for example, a phonebook, a message, a still image and a video. Also, the memory may store data regarding various patterns of vibrations and sounds output in response to a touch input on the touchscreen.

The memory may include one or more types of storage medium, e.g., a flash memory, a hard disk, a MultiMediaCard micro type, a memory card, such as a secure digital (SD) card and an extreme digital (XD) card, a random-access memory (RAM), a static random-access memory (SRAM), a read-only memory (ROM), an electrically erasable programmable read-only memory (EEPROM), a PROM, a magnetic memory, a magnetic disk and an optical disk. Further, the mobile communication terminal may manage a web storage that performs a storage function of the memory on the Internet.

The controller generally controls overall operations of the mobile communication terminal. For example, the controller performs a control operations and a process related to a voice call, a data communication, and a video call. The controller may also include a multimedia module for multimedia playback. The multimedia module may be provided in the controller or separately configured from the controller.

The controller may perform a pattern recognition process to recognize a handwriting input and/or a painting input on the touchscreen as a letter or an image.

The power supply may include a battery, which is provided with external power and internal power and supplies power needed for an operation of a component of the mobile communication terminal according to the control of the controller.

Exemplary embodiments illustrated in the specification may be realized in recording media readable by a computer or equivalents thereof using software, hardware, and combinations thereof.

In a hardware level, the application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for conducting functions may be applied.

In a software level, a software module to implement at least one function or operation may be embedded. Software codes may be realized by a software application written in a proper program language. Further, the software codes may be stored in the storage unit and implemented by the controller.

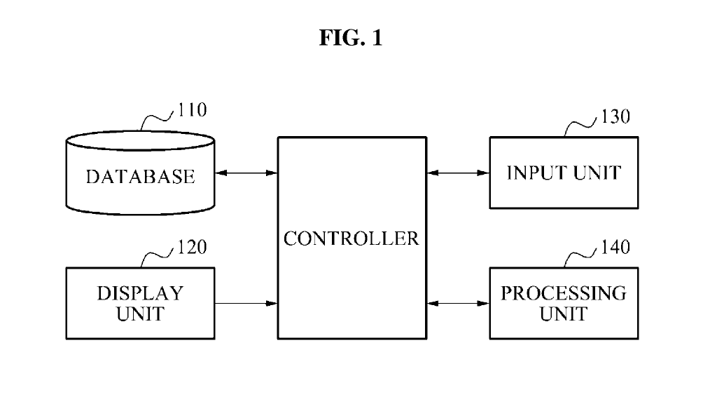

FIG. 1 is a block diagram illustrating a configuration of an apparatus of executing an application according to an exemplary embodiment of the present invention.

The apparatus (“application executing apparatus”) may be a device that executes a widget on the mobile communication terminal, and may include a database 110, a display unit 120, an input unit 130, and a processing unit 140.

The application executing apparatus may provide one or more applications, for example, a widget in an intuitive application form to enable immediate use of a desired service on the idle screen of the mobile communication terminal. In the following description, a provided application may be referred to as a “widget”, but it should be noted that the application executing apparatus may provide various kinds of applications, without limiting to the widget.

The database 110 stores identifier (ID) information about one or more applications, for example, ID information about at least one individual widget. The display unit 120 may display a multi-execution window on a screen of the mobile communication terminal, which may be displayed separately from an application execution window displayed on the screen. The multi-execution window may be a widget window configured to execute multiple widgets in the multi-execution window. The executions of the multiple widgets may be performed consecutively or simultaneously. Further, the execution status of one of the multiple widgets may be displayed if the multi-execution window size is limited by the screen size of the apparatus. For example, only one executed widget may be displayed on the multi-execution window and another widget may be displayed by replacing the displayed widget or by scrolling or swiping.

The input unit 130 receives an input of a signal for selection of the one or more applications, for example, a signal for selection of any one of the one or more widgets.

The processing unit 140 executes an application corresponding to the selection signal based on the ID information and outputs the application to the multi-execution window, for example, executes a widget corresponding to the selection signal and outputs the widget to the multi-execution window

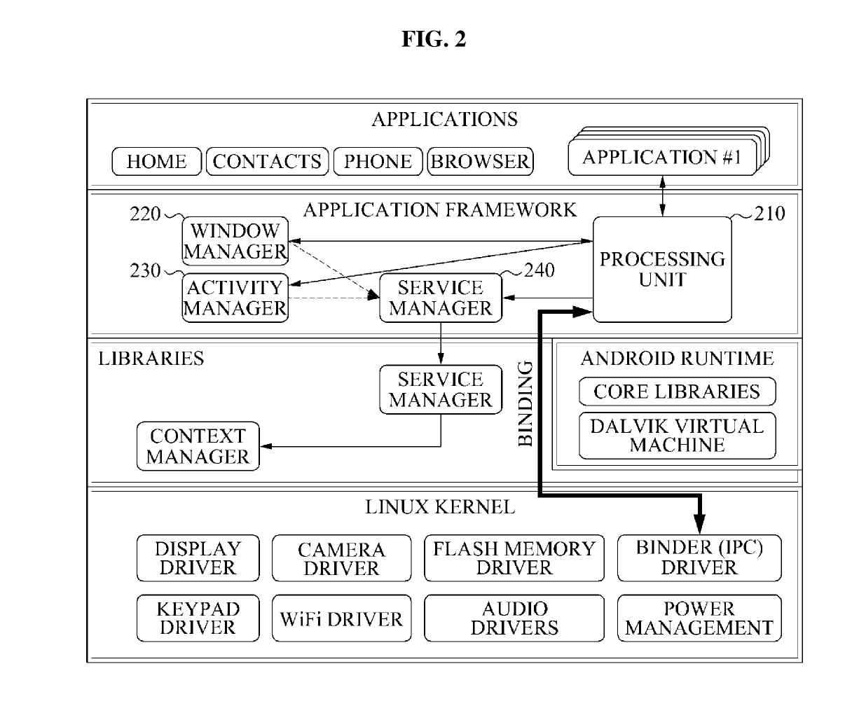

FIG. 2 is a block diagram illustrating a widget service providing structure according to an exemplary embodiment of the present invention.

A processing unit 210 may be configured from among various operating systems (OSs), for example, an Android™ as shown in FIG. 2. However, different OSs, such as Linux, iOS® and Window® Mobile, may be also used in addition to or instead of the Android™.

Here, the ID information may include information to distinguish an application corresponding to a selection signal from among one or more applications and index information. The index information may include a number that increases one by one in order of applications selected according to the selection signal.

Referring to FIG. 2, if the processing unit 210 is configured in the Android™ operating system, the processing unit 210 may be located in an application framework to execute a multi-execution window based on a user input in association with a Window Manager 220, an Activity Manager 230 and a Service Manager 240.

For example, the Window Manager 220 may set up and control an execution window on which an application is executed in the framework, the Activity Manager 230 may function to control a lifecycle of the executed application and to maintain a back stack for user navigation, and the Service Manager 240 may serve to retrieve a system service corresponding to the application.

In general, a kernel is a computer program that manages input and output requests from software and transforms the requests into data processing instructions for hardware components, such as a central processing unit and other electronic components. However, in the specification, a “kernel” may also refer to a component of providing a plurality of basic services to other components of a computer OS and function to manage an address space of the OS in the memory or storage unit and to serve out the address space to all peripheral devices and other components using services.

A “library” may refer to a collection of subprograms frequently used in a computer program, which is a collection of files storing one or more routines or functions to be linked to other programs and may be in a complied form, that is, an object module.

A “runtime” refers to a time during which a computer program is running, and a runtime library may denote a library or program in basic code used by a particular compiler or virtual machine to manage a program written within a computer language.

A “framework” refers to a basic frame structure to apply various kinds of software and may correspond to a frame to bind an application, a library, a language, and different software configuration into a set.

The application executing apparatus may collect application property information to configure application list information, for example, collect widget property information to configure widget list information.

The application executing apparatus may further include a property information collection unit to collect application property information about each application, an application configuration unit to configure each application using the application property information, and a list configuration unit to configure application list information by listing the configured application. Further, if a new application is configured by the application property information, the list configuration unit may update the application list information and store the updated application list information in the database.

For example, if an application provided by the application executing apparatus is a widget, the property information collection unit, the application configuration unit, and the list configuration unit may correspond to a widget property information collection unit, a widget configuration unit and a widget list configuration unit, respectively.

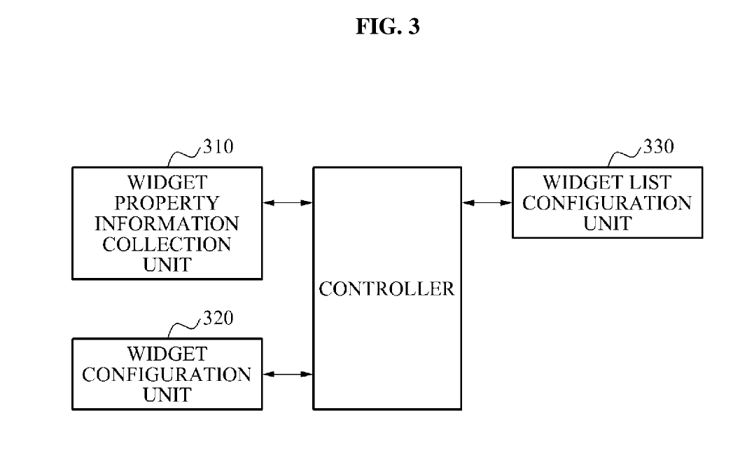

FIG. 3 is a block diagram illustrating additional components of an application executing apparatus to collect widget property information and to configure widget list information according to an exemplary embodiment of the present invention.

The application executing apparatus may include a widget property information collection unit 310, a widget configuration unit 320, and a widget list configuration unit 330, as shown in FIG. 3, in addition to the configuration of FIG. 1, which is not shown in FIG. 3.

The widget property information collection unit 310 may collect widget property information about each widget, and the widget configuration unit 320 may configure each widget using the widget property information. The widget list configuration unit 330 may list each configured widget to configure widget list information, and update the widget list information and the updated widget list information in the database when a new widget is configured by the widget property information.

For example, an executable file installed on the mobile communication terminal, for example, an application package (APK), may have a plurality of pieces of widget property information through a manifest when created, and the property information may include launcher property information and widget property information. The launcher property information may be property or shortcut information to directly execute an application, and the widget property information may be function information of directly executing a function of a widget. A package manager may separate the APK, and collect and store widget property information in the memory of the mobile communication terminal if there is the widget property information. Here, the collected widget property information may include information about a layout size of a widget.

Referring back to FIG. 1, the database 110 may store information about a widget selected by the user among widgets stored in the memory, which will be described in detail.

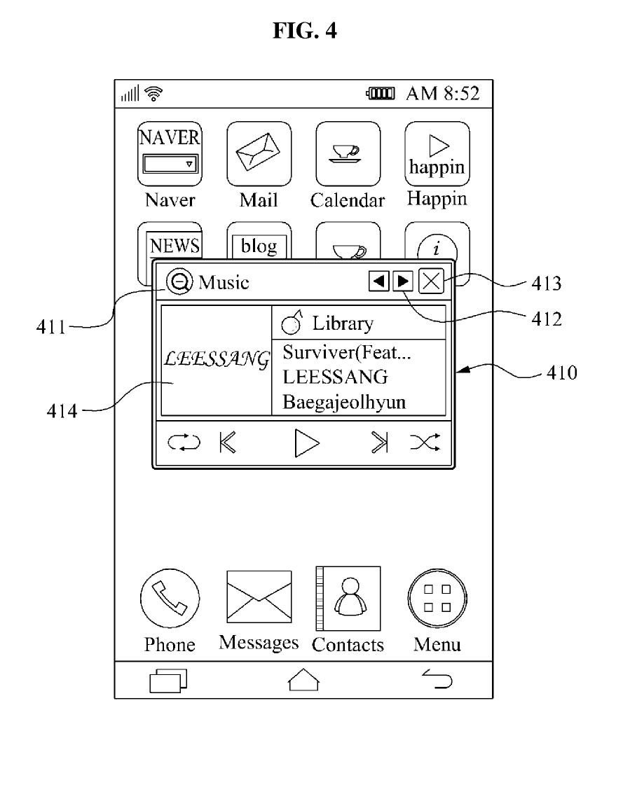

FIG. 4 illustrates a widget executed and displayed on a multi-execution window according to an exemplary embodiment of the present invention.

Referring to FIG. 4, the multi-execution window 410 is an execution window displayed independently of various types of content displayed on the screen of the mobile communication terminal, such as an application, an icon, and an execution window. The multi-execution window 410 may be displayed in an upper layer than a layer where an application execution window is displayed and be always displayed on a top layer among layers configured on the screen of the mobile communication terminal, e.g., always on top (AOT) windows.

The multi-execution window 410 may include a title bar to indicate a name of an application being executed, a switch icon to switch to a previous application or a next application, and an exit icon to shut down or terminate the application being executed.

For example, the multi-execution window 410 may display a widget selected by a selection signal, in which a title bar 411 to present a name of the widget may be displayed. Further, the title bar 411 may be displayed along with a switch icon 412 to switch to a previous widget or a next widget and an exit icon 413 to shut down or terminate the widget being executed, enabling users to manipulate the widget. The exit icon 413 may terminate the display of the multi-execution window 410.

Further, the multi-execution window 410 may be divided into a title bar section 411 and a widget section 414. Here, the widget section 414 may be dynamically changed based on a layout and be hidden while the title bar section 411 is still displayed, thereby minimizing the size of the multi-execution window 410. As described above, the exit icon 413 to shut down or terminate a registered widget and the switch icon 412 to switch to a previous widget or a next widget may be displayed in the title bar section 411. Further, a switch command to move to a previous or next widget may be implemented by a touch or drag input, instead of displaying the switch icon 412 in the title bar section 411.

When the multi-execution window is having a characteristic of “always displayed on top,” the multi-execution window may be always displayed over one or more application execution windows but be displayed under a main system execution window.

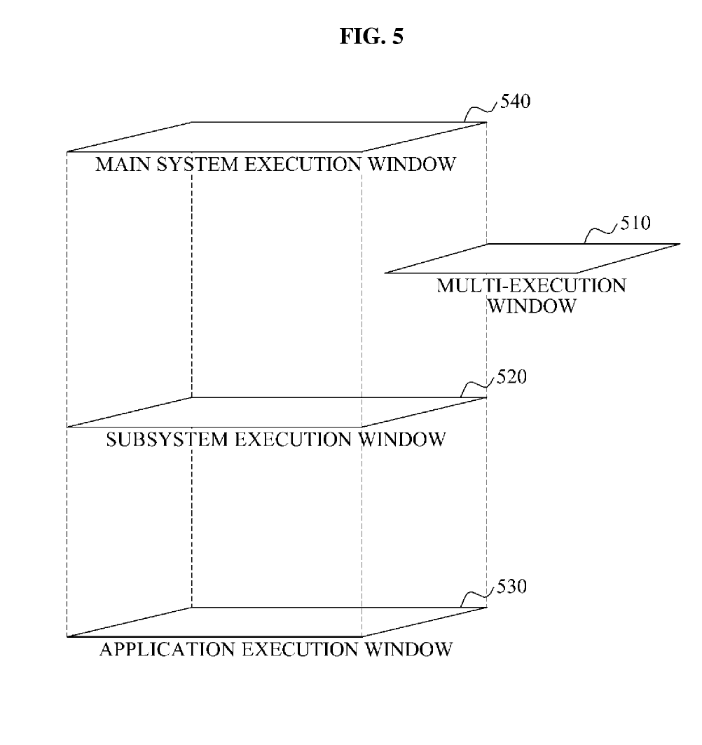

FIG. 5 illustrates a display location of a multi-execution window according to an exemplary embodiment of the present invention.

Referring to FIG. 5, the multi-execution window 510 may be displayed over an application execution window 530 for at least one application registered in the mobile communication terminal (“application execution window”) and/or a subsystem execution window 520. Here, the multi-execution window 510 may be displayed under a main system execution window 540 to maintain a main system layout of the mobile communication terminal but be also displayed at different locations based on a configuration of layers.

For example, the main system execution window 540 is a basic system execution window provided by the operating system, which may be an execution window for executing an application always running while the mobile communication terminal operates or may be an execution window for displaying a setting directly relevant to the operating system, for example, a system information display window that is displayed when a top execution window of an Android™ operating system is flicked down.

The subsystem execution window 520 may refer to an execution window for maintaining a basic layout provided by the operating system. In the Android™ operating system, the subsystem execution window 520 may refer to an execution window for arranging an application execution icon disposed at the bottom and a top execution window for displaying status information about the operating system, for example, a clock and a running application.

The application execution window 530 is an execution window on which an application executable in the operating system is running and may be displayed on a separate layer from the subsystem execution window 520.

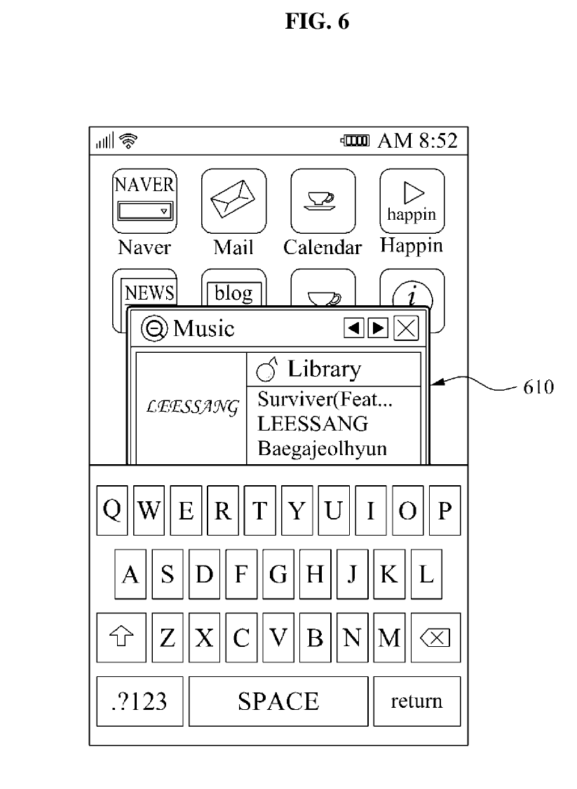

FIG. 6 illustrates a widget executed and displayed on a multi-execution window according to another exemplary embodiment of the present invention.

Referring to FIG. 6, when the mobile communication terminal implements an input application, such as a keypad, to receive an input signal, the multi-execution window 610 may be displayed under the input application.

For example, the multi-execution window 610 may be displayed over an application window layer on which any executed application is displayed. However, when a main system execution window, for example, a top menu bar supported by the operating system of the mobile communication terminal, is dragged down and displayed, the multi-execution window 610 may be hidden by the main system execution window 540 of FIG. 5. For example, an input method editor (IME), that is, a keyboard, provided by a main system may be displayed over the multi-execution window 610.

Further, the multi-execution window 610 may switch to a different widget from a widget currently running by a user input. For example, the multi-execution window 610 may switch to another widget by the user, e.g., a double tapping with the user's finger or pressing a previous button or a next button in the title bar.

Moreover, the multi-execution window 610 may be displayed over a switched application execution window even when an application execution is switched. For example, even though the user makes a motion with a finger of switching to a different page of the application execution window under the multi-execution window 610 to change to the page of the application execution window, the multi-execution window 610 may be kept displayed over the application execution window. For example, the display of the multi-execution window 610 may be maintained while the application execution window changes from a display of the execution status of a first application to a display of the execution status of a second application.

The application executing apparatus may adjust a layout size of the multi-execution window.

Referring to FIG. 1, the processing unit 140 may include an application change determination unit to determine whether there is a request for a change of an application displayed on the multi-execution window, an application size determination unit to determine layout size information about the changed application in response to the change request, and a layout change unit to change a layout of the multi-execution window on which the application is displayed based on the layout size information.

For example, if an application provided by the application execution apparatus is a widget, the application change determination unit, the application size determination unit, and the layout change unit may correspond to a widget change determination unit, a widget size determination unit, and a layout change unit, respectively.

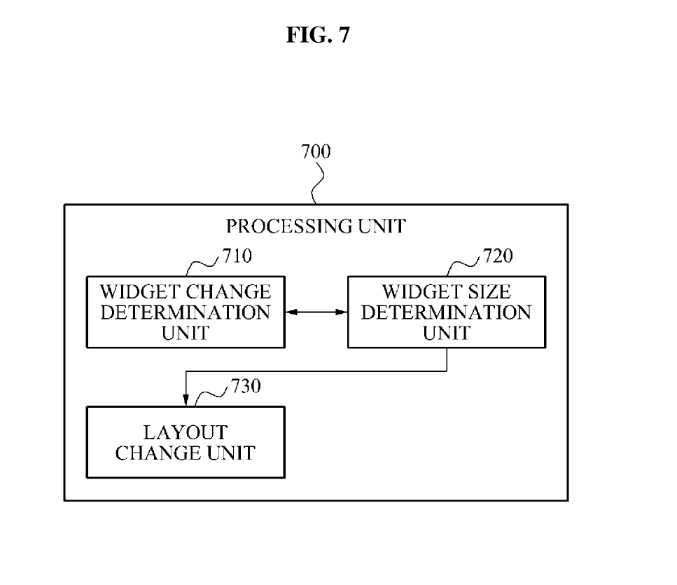

FIG. 7 is a block diagram illustrating a configuration of a processing unit according to an exemplary embodiment of the present invention.

Referring to FIG. 7, the processing unit 700 of the application executing apparatus may include a widget change determination unit 710, a widget size determination unit 720, and a layout change unit 730.

The widget change determination unit 710 may determine whether there is a request for a change of a widget displayed on a multi-execution window, the widget size determination unit 720 may determine layout size information about the changed widget in response to the change request, and the layout change unit 730 may change a layout of the widget displayed on the multi-execution window based on the layout size information.

For example, when the user flicks the multi-execution window from side to side, selects a previous or next widget from a widget list, or presses the switch icon 412 to select a previous or next widget as shown in FIG. 4, the application executing apparatus may determine whether there is a change of a widget based on an index change of the selected widget or ID information change of the widget. However, aspects are not limited as such and other methods may be adopted to determine whether there is a change of a widget by the user.

When the widget is changed, the application executing apparatus may receive layout size information about the widget from ID information about the changed widget or relevant information and determine a size of the widget. Further, the application executing apparatus may change a layout of the widget based on the layout size information about the widget and displays the widget in the changed layout. Here, a layout of the multi-execution window may be automatically adjusted according to the size of the widget. For example, the multi-execution window may be adjusted in proportion to the size of the widget.

Hereinafter, examples of various functions of a multi-execution window will be described.

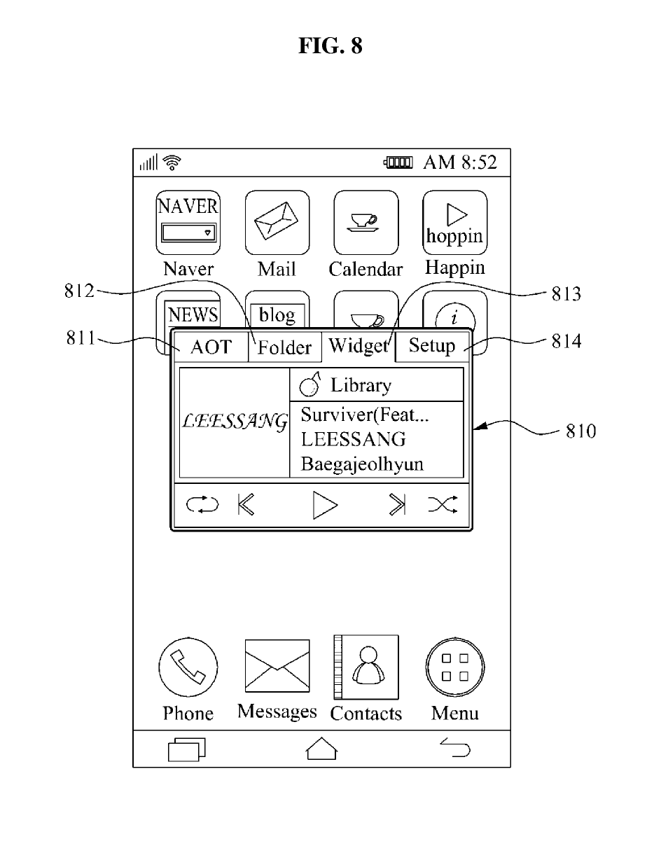

FIG. 8 illustrates a displayed multi-execution window according to an exemplary embodiment of the present invention.

Referring to FIG. 8, the multi-execution window 810 may occupy part of the screen of the mobile communication terminal, display an application corresponding to an input signal input to the mobile communication terminal, and be moved to a random position on the screen.

The application executing apparatus may arrange one or more widgets within a layout of the multi-execution window 810 and moves an arranged widget to any position.

For example, the multi-execution window 810 may dispose an icon of at least one widget or display a list of one or more widgets within the layout of the multi-execution window 810 by a user input, for example, a long touch or double touch on a desktop.

Further, the application executing apparatus may provide other additional functions through the multi-execution window 810 in addition to the widgets. In this case, the multi-execution window 810 may further include an input tool to distinguish other additional functions running and the widgets running. Although FIG. 8 illustrates that the multi-execution window 810 includes tabs 811, 812, 813, and 814 as the input tool, the input tool may not be limited thereto but be modified as different types, for example, a list or an icon. The multi-execution window 810 may include a widget tab 813 to display at least one widget and a preload application tab 811 to display at least one preloaded application. In FIG. 8, the preload application tab 811 is represented by “AOT”, which is an illustrative example to indicate the preload application tab. Further, the multi-execution window 810 may further include a folder tab 812 on which an icon of at least one application is disposed. In FIG. 8, the folder tab 812 is represented by “folder”, which is an illustrative example to indicate the tab to show a collection of icons of applications. In addition, the multi-execution window 810 may further include a setup tab 814 for the user to set one of the preload application tab, the application tab, and the widget tab in execution.

For example, the widget tab 813 may present a menu of a widget registered by the user among one or more widgets, and the setup tab 814 may be associated with a setup application capable of registering or canceling (undo display of) at least one of the widgets. Here, if an icon disposed on the preload application tab 811 is selected, a corresponding application may run on the multi-execution window 810. If an icon disposed on the folder tab 812 is selected, a corresponding application may run on a home screen instead of on the multi-execution window 810. That is, the user may distinguish an application to run on the multi-execution window 810 from an application to run on the home screen in registration.

A menu of the multi-execution window 810 may be displayed on the screen of the mobile communication terminal when an input signal with respect to a preset key or gesture is received while the mobile communication terminal is operating. For example, the application executing apparatus may display the menu of the multi-execution window 810 if the user presses a recently implemented list displayed on an input window for a long time, taps the input window with two or more fingers, or double-taps the input window with one finger.

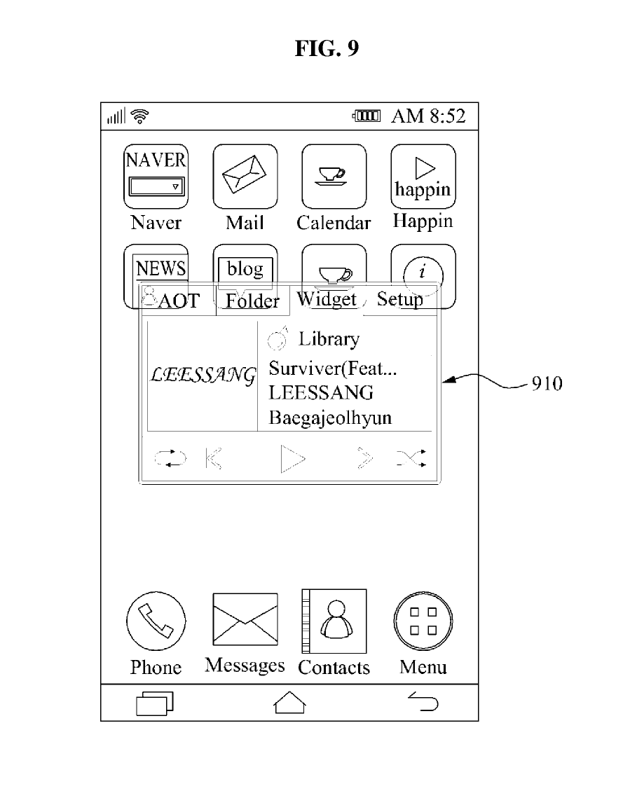

FIG. 9 illustrates a displayed multi-execution window according to another exemplary embodiment of the present invention.

Referring to FIG. 9, the multi-execution window 910 may be displayed over an application execution window displayed on the screen of the mobile communication terminal, with display contrast adjusted to a lower level such that background content is seen through the multi-execution window 910. More specifically, the multi-execution window 910 may be partially transparent and the transparency degree may be controlled. For example, when the multi-execution window 910 is running, the application executing apparatus may display the multi-execution window 910 to be relatively opaque so that a background of the multi-execution window 910 is not visible. Further, when the home screen is selected to be run in the foreground by touching the home screen, the application executing apparatus may change the multi-execution window 910 relatively transparent so that the background of the multi-execution window 910 is visible and the home screen appears to be activated.

Hereinafter, a method of registering a widget to execute the widget according to an exemplary embodiment of the present invention will be described.

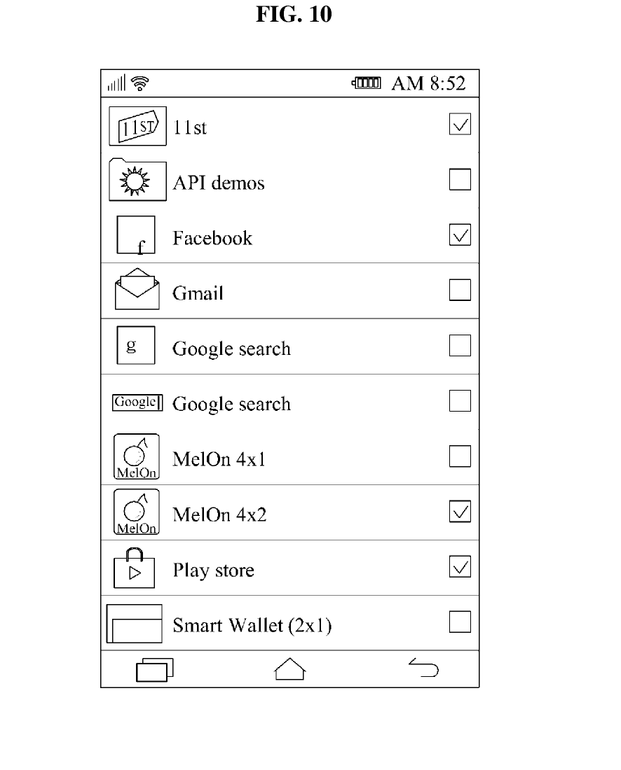

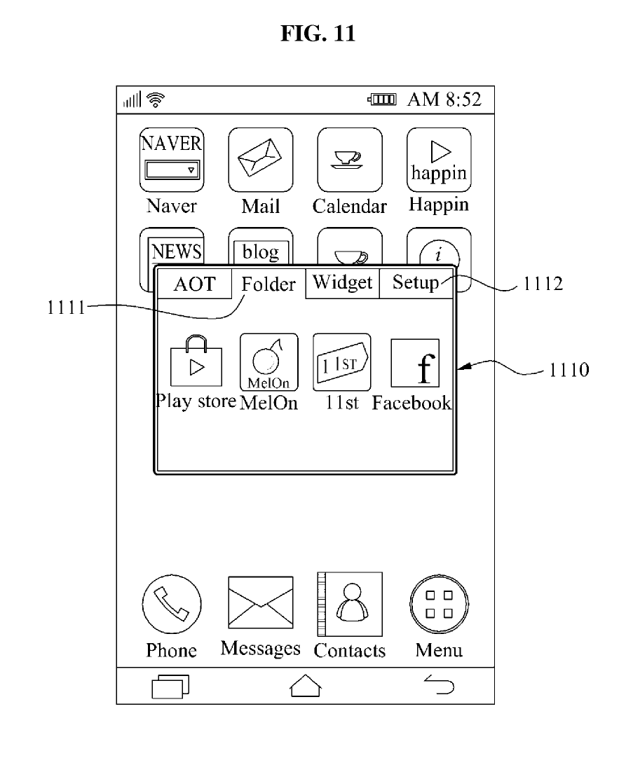

FIG. 10 illustrates a widget list or an application list to be registered in the widget tab or folder tab through the setup tab, and FIG. 11 illustrates that an application icon selected from the application list is registered in the folder tab of the multi-execution window.

Referring to FIG. 1 to FIG. 10, the display unit 120 of the application executing apparatus may display a list of applications or widgets installed in the mobile communication terminal, and display at least one widget or application corresponding to a registration signal on the multi-execution window when the registration signal with respect to the at least one application or widget to be displayed on the multi-execution window is input through the input unit 130. However, aspects are not limited as such and different methods may be adopted to register a widget or application to be displayed on the multi-execution window.

For example, the user may touch a desktop for a long time to display executable widget icons in an area of the home screen, for instance, a bottom area of the home screen, and drag and drop an icon to register within the layout of the multi-execution window, thereby registering the icon.

Alternatively, when an application icon to support a widget is selected, the application executing apparatus may display a popup to check whether to execute the widget in the multi-execution window at one side of the icon, and register the widget to be displayed on the multi-execution window when execution of the widget on the multi-execution window is selected.

The application executing apparatus may register a widget according to a method among various possible options. Examples of the methods will be described with reference to FIG. 10 and FIG. 11.

When a setup tab 1112 is selected as shown in FIG. 11, the application executing apparatus may display a widget setup screen. A list of widgets installed in the mobile communication terminal may be displayed on the widget setup screen as shown in FIG. 10. Further, the application executing apparatus may display a preload application setup tab, a folder setup tab, and a widget setup tab if the setup tab is selected. Also, the application executing apparatus may display a list of all widgets installed in the mobile communication terminal if the widget setup tab is selected. In addition, the application executing apparatus may display the list of all applications installed in the mobile communication terminal if the folder setup tab is selected.

As described above, an executable file installed in the mobile communication terminal, e.g., an APK, may have a plurality of widget properties through a manifest when created, and the properties may include launcher property information and widget property information. The launcher property information may be a property or shortcut to directly execute an application, and the widget property information may be function information of directly executing a function of a widget. A package manager may separate the APK, and extract and store widget property information in the memory of the mobile communication terminal if the widget property information exists. Extracting and storing widget property information in the memory may be performed whenever a new application is downloaded. If an application is downloaded, the application is examined to detect whether the application includes widget property information in the APK, and the widget property information is stored in the memory, if extracted, to update widget list information. The updated widget list information may be added to an existing widget and displayed when the various widget registration methods described above are implemented.

When the widget setup tab is selected for registration of a widget, the application executing apparatus may import all widgets stored in the memory and display the list of all widget on the multi-execution window. Here, if different sizes of widgets are supported for the same application, the multi-execution window may display a widget including size information.

At least one widget to be registered in the widget tab may be selected from the list of all widgets, and ID information about the widget may be stored in the database. The ID information may include information to distinguish the widget and index information. The index information may include a number that increases one by one in order of the selected widgets. The index information may specify order of widgets to be displayed when the switch icon 412 of FIG. 4 is selected. Further, the database may store information about a registered widget, which will be described below.

Referring to FIG. 10, the application executing apparatus may provide a check box on a right side of the widget list to register a widget to display on the multi-execution window. For example, the application executing apparatus registers four widgets, such as “11ST,” “Facebook,” MelOn 4×2” and “Play Store,” from the widget list, and the registered widgets are displayed in the widget section 414 of FIG. 4 and may be changed based on a widget switch command. As shown in FIG. 11, when an application to be registered in a folder tab 1111 is selected through the setup tab 1112, the registered application may be displayed as an icon in the folder tab 1111 or in association with the folder tab 1111.

Referring back to FIG. 1, the display unit 120 of the application executing apparatus may display the list of all applications or widgets installed in the mobile communication terminal, and cancel display of at least one widget or application in response to a registration cancelation input, e.g., an undo signal, on the multi-execution window when the registration cancelation input, e.g., the undo signal, with respect to the at least one application or widget to be canceled from the multi-execution window is input through the input unit 130.

For example, the user may select the setup tab from the menu of the multi-execution window to verify the list of all widgets (“widget list”) installed in the mobile communication terminal and cancel a widget to be removed from the multi-execution window among one or more widgets displayed on the widget list to remove the display of the widget on the widget tap of the menu of the multi-execution window.

The database 110 may store an ID of at least one widget and relevant information. For example, the database 110 may store an ID of at least one widget corresponding to a registration signal and relevant information and may store an ID of at least one widget corresponding to a display cancelation signal and relevant information.

For example, ID information may include information to distinguish a widget corresponding to a selection signal from among widgets and index information. The index information may include a number that increases one by one in order of widgets selected according to the selection signal. The database 110 may further include relevant information to execute the at least one widget, which may include layout size information about each widget.

Here, ID information about a widget may refer to a widget ID to identify widgets stored in the memory of the mobile communication terminal, and the widget ID may be represented by a certain number. Widgets that are extracted from the same application but have different layout sizes may have different IDs. Also, widgets that are extracted from the same application but registered to run differently on the home screen and the multi-execution windows may have different IDs. The database 110 may store ID information about a widget registered to run on the multi-execution window.

Further, the relevant information may include information used to execute a widget. For instance, for a weather widget, which provides weather information, the relevant information may be user location information. In a widget relevant to a picture gallery, the relevant information may be information about pictures to be displayed on the widget. For example, when a gallery widget is executed, the relevant information may be information about a picture selected for display through the widget among images stored in a gallery. Further, the relevant information may include information about a widget size.

The application executing apparatus may manage the ID of the at least one widget and the relevant information stored in the database 110 in a list form and switch to a different widget from a currently running widget through a specific operation. For example, the application executing apparatus may switch to the different widget by the user tapping with two fingers or pressing the previous button or next button on the title bar.

When a signal to operate a different widget is detected, the application executing apparatus may extract an index of the currently displayed widget from the widget list and recognize and display the different widget from the list by adjusting the index.

For example, when the user presses the next button, the application executing apparatus may increase the index by one to determine the next widget from the widget list and execute the widget on the multi-execution window. Here, if the index of the currently displayed widget is the last index number in the widget list, the application executing apparatus may change the index to 0 and execute the widget having the index 0 in the widget list.

The layout size of the multi-execution window may be adjusted based on a layout size of a selected widget. For example, when the selected widget has a 2×2 size, the layout size of the multi-execution window may be adjusted to the 2×2 size. When the user presses the next button of the switch icon to increase the index and to execute another widget, the layout size of the multi-execution window may be adjusted based on the size of the other widget. For example, if the other widget has a 1×4 layout, the multi-execution window may be executed with the layout size being adjusted from the 2×2 layout size of the previous widget to the 1×4 layout size of the next widget.

Hereinafter, an operation method of the application executing apparatus according to an exemplary embodiment of the present invention will be described.

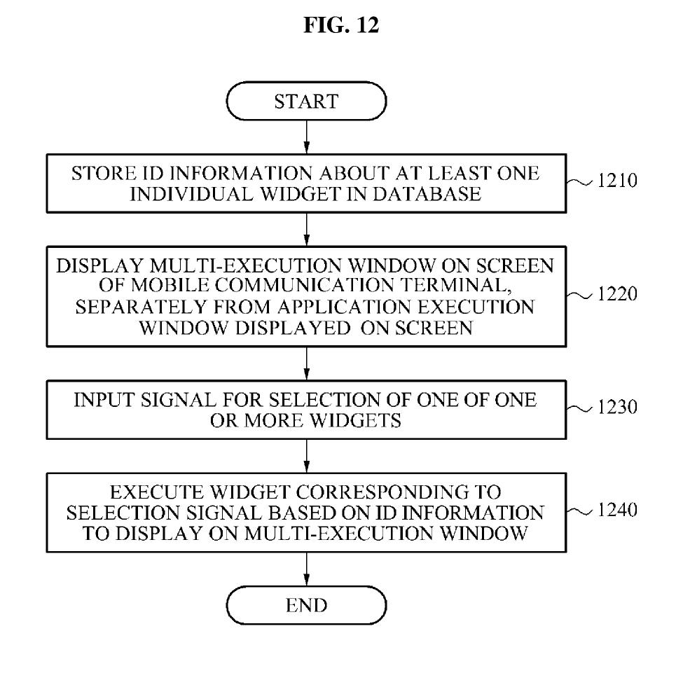

FIG. 12 is a flowchart illustrating an operation method of the application executing apparatus according to an exemplary embodiment of the present invention.

Referring to FIG. 12, the application executing apparatus stores ID information about at least one individual widget in the database in operation 1210.

The application executing apparatus displays a multi-execution window on the screen of the mobile communication terminal. The multi-execution window is displayed separately from an application execution window displayed on the screen in operation 1220. Further, the application executing apparatus receives an input of a signal for selection of one of widgets, in operation 1230, and executes a widget corresponding to the selection signal based on the ID information to display the executed widget on the multi-execution window in operation 1240.

The application executing apparatus may collect widget property information about the at least one individual widget, configure each widget based on the widget property information, and list the configured widgets to configure widget list information.

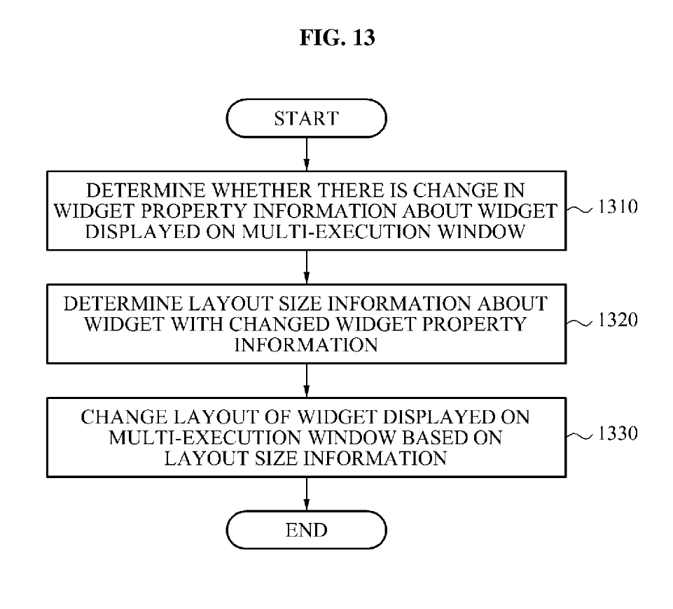

FIG. 13 is a flowchart illustrating a method of changing a layout of a widget based on a change of widget property information according to an exemplary embodiment.

Referring to FIG. 13, the application executing apparatus may determine whether there is a change in widget property information about a widget displayed on a multi-execution window in operation 1310, determine layout size information about the widget with the changed widget property information in operation 1320, and change the layout of the widget to be displayed on the multi-execution window based on the layout size information in operation 1330.

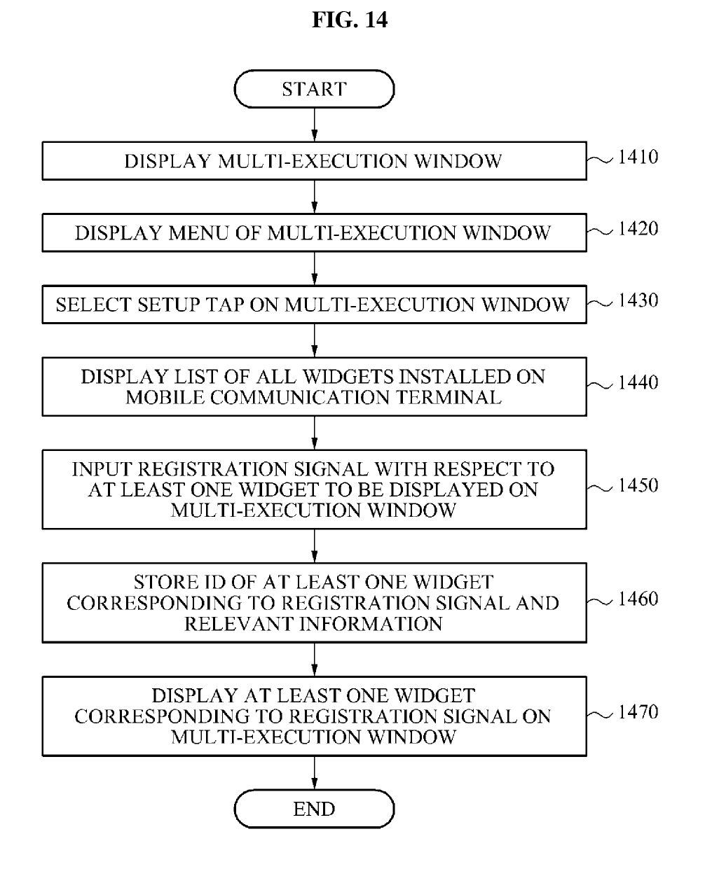

FIG. 14 is a flowchart illustrating a method of registering a widget in a multi-execution window according to an exemplary embodiment of the present invention.

Referring to FIG. 14, the application executing apparatus may display a multi-execution window in operation 1410 and display various execution tabs of the multi-execution window in a menu in operation 1420. Further, the application executing apparatus may display the list of all widgets installed in the mobile communication terminal in operation 1440 if the user selects a setup tab from among the execution tabs of the multi-execution window in operation 1430.

The application executing apparatus may receive an input of a registration signal with respect to at least one widget to be displayed on the multi-execution window in operation 1450, store an ID of the at least one widget relevant to the registration signal and relevant information in operation 1460, and display the at least one widget relevant to the registration signal on the multi-execution window in operation 1470. Here, the relevant information may include information used to execute the widget. For instance, for a weather widget, which provides weather information, the relevant information may be user location information. For a widget relevant to a picture gallery, the relevant information may be information about pictures to be displayed on the widget.

The application executing apparatus may display the multi-execution window and display various execution tabs of the multi-execution window in the menu. Further, the application executing apparatus may display the list of all widgets installed in the mobile communication terminal as the user selects the setup tab among the execution tabs of the multi-execution window.

The application executing apparatus may receive an input of an undo signal (or display cancelation signal) with respect to at least one widget to be canceled from a display on the multi-execution window, store an ID of the at least one widget relevant to the undo signal and relevant information, and cancel the display of the selected widget relevant to the undo signal on the multi-execution window.

The application executing apparatus displays the multi-execution window having a determined layout size by overlapping the layer of the multi-execution window on the layer of an application execution window. Here, the multi-execution window may be displayed with a preset size over the home screen, and the size of the multi-execution window may be adjusted corresponding to the size of the currently displayed or selected widget.

The application executing apparatus may display the various execution tabs of the multi-execution window in the menu, and display at least one widget registered, in advance, on the multi-execution window as the user selects an execution tab on the multi-execution window.

The application executing apparatus may receive an input of a signal for selection of one of widgets, configure a display method of the widget relevant to the selection signal, and execute the widget according to the display method to display within a layout of the multi-execution window. Here, the application executing apparatus may adjust the size of the multi-execution window corresponding to a size of an application selected as described above, and switch to the next widget or previous widget using the switch icon on the title bar or shut down the widget using the exit icon.

According to aspects of the present invention, a widget or a widget application may be a type of an application configured to be executed in a widget window. The multi-execution window is one example of the widget window, and the widget may be executed in the widget window while a non-widget application, e.g., a general application, is executed in an application execution window. The widget window may be disposed on the application execution window such that the widget window may cover a portion of the application execution window.

A widget may be a first type widget, which has a corresponding application executable in the application execution window. For example, as shown in FIG. 9, the music widget is executed and displayed in the multi-execution window 910, and the music widget may have a corresponding music application executable in the application execution window. If the corresponding music application is executed by selecting a music application icon displayed on the screen of the apparatus, the music application may be launched and displayed in the entire screen of the application execution window. However, the music widget may be configured to display partial information and functions in the multi-execution window for customized manipulation of the widget while using other applications on the application execution window.

The execution of the first type widget may be switched to an execution of an application corresponding to the first type widget, or vice versa. For example, a user may execute a music widget in the multi-execution window and then execute a music application in an application window by switching the execution of the music widget to the execution of the music application. The execution switching may be performed in response to a user input and the execution status may be seamless and natural. More specifically, if the user inputs an input, e.g., a gesture, a touch, and the like, for the execution switching when a music widget is playing back the third track of the music list, the third track of the music list may be seamlessly executed in the application execution window. Similarly, the execution of the music application may be switched to the execution of the music widget in the multi-execution window. Then, the application execution window may switch another background application as new foreground application in the application execution window.

The widget may be a second type widget that does not have a corresponding application executable in the application execution window or may be a small application configured to be disposed on a portion of a display screen window, such as the home screen and a web page, with limited functionalities. A widget may be a transient or auxiliary application that occupies a portion of the display screen and performs a function with information fetched from the executed application in the application execution window or from other sources.

The widget window may include a widget menu. The widget menu may be an always on top (AOT) menu located on an application execution window layer. The widget menu may be located in the layer between the application execution window and the main system execution window as shown in FIG. 5. The widget menu may include an AOT tab, a folder tab, a widget tab, and a setting tab as shown in FIG. 8. The widget menu may be displayed if a designated key is touched or pressed, or a specific gesture is received.

According to aspects of the present invention, a mobile communication terminal may store identifier (ID) information about each of applications in a database, display a multi-execution window on a screen of the mobile communication terminal, receive an input of a signal for selection of one or more of the applications, and execute the application corresponding to the selection signal based on the ID information to display the selected one on the multi-execution window. The multi-execution window may be displayed separately from an application execution window displayed on the screen.

As described above, the application executing apparatus and the application executing method may select at least one user-configured widget using a setup tab and execute the selected widget on the multi-execution window displayed over the application execution window on the home screen. Further, the application executing apparatus and the application executing method may execute a previous or next widget through the multi-execution window, enabling the user to register and execute a widget regardless of a space for placement and execution of the home screen. Moreover, the user may execute at least one desired widget on a single home screen, thereby improving utilization of the widget on the mobile communication terminal.

According to an exemplary embodiment of the present invention, the user may register and execute an application regardless of the limited space for placement and execution of a home screen.

According to an exemplary embodiment of the present invention, the user may execute at least one desired application on a single home screen.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media, such as hard disks, floppy disks, and magnetic tape; optical media, such as CD ROM disks and DVDs; magneto-optical media, such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. An apparatus to provide an interface for multiple widgets, the apparatus comprising:
a storage device to store a widget;
a controller to control the widget in a widget window configured to be displayed on a layer different from a layer for displaying an executable application; and
a display to display the widget window, the widget window being configured to manage multiple widgets.

2. The apparatus of claim 1, wherein the widget is configured to be executed in the widget window.

3. The apparatus of claim 2, wherein the widget is a widget form of an application executable in an application execution window.

4. The apparatus of claim 1, wherein the layer on which the widget window is displayed is disposed on the layer for displaying an executable application, the layer for displaying an executable application corresponding to an application execution window larger than the widget window.

5. The apparatus of claim 1, wherein the widget window comprises at least one of execution status information of the widget, a first interface to control an execution of the widget, and a second interface to display, in the widget window, another widget in replacement of the executed widget.

6. The apparatus of claim 1, wherein the widget window comprises a tab to manage the widget window.

7. The apparatus of claim 6, wherein the tab comprises at least one of an always on top (AOT) tab to display a preloaded application, a folder tab to display an icon of an executable application, and a widget tab to display a menu of a widget registered by a user.

8. The apparatus of claim 7, wherein the tab comprises a setup tab to set a configuration of the AOT tab, the folder tab, or the widget tab.

9. The apparatus of claim 1, wherein the controller determines a size of the widget window according to size information of the widget, and
wherein, if the widget window displays another widget in response to an input signal, the size of the widget window is changed according to size information of the other widget.

10. The apparatus of claim 1, wherein the display displays a widget list for registering one or more widgets in the widget window, the widget list comprising a list of widgets and a selection interface for a user to select one or more widgets for registration.

11. The apparatus of claim 1, wherein the storage device further stores an identification of the widget.

12. A method for providing an interface for multiple widgets, the method comprising:
receiving an input to display a widget window; and
displaying a widget window on a layer different from a layer for displaying an executable application, the widget window being configured to manage multiple widgets.

13. The method of claim 12, further comprising executing a first widget in the widget window.

14. The method of claim 13, wherein the widget is a widget form of an application executable in an application execution window.

15. The method of claim 12, wherein the layer on which the widget window is displayed is disposed on the layer for displaying an executable application, the layer for displaying an executable application corresponding to an application execution window larger than the widget window.

16. The method of claim 12, wherein the widget window comprises at least one of execution status information of a first widget, a first interface to control an execution of the first widget, and a second interface to display, in the widget window, a second widget in replacement of the executed first widget.

17. The method of claim 12, wherein the widget window comprises a tab to manage the widget window.

18. The method of claim 17, wherein the tab comprises at least one of an always on top (AOT) tab to display a preloaded application, a folder tab to display an icon of an executable application, and a widget tab to display a menu of a widget registered by a user.

19. The method of claim 18, wherein the tab comprises a setup tab to set a configuration of the AOT tab, the folder tab, or the widget tab.

20. The method of claim 12, further comprising:
determining a size of the widget window according to size information of a first widget to be displayed in the widget window; and
in response to an input signal to display a second widget in the widget window, resizing the widget window according to size information of the second widget.

21. A non-transitory computer-readable recording medium comprising an executable program for instructing a computer, when executed by the computer, to perform the method of claim 12.
